(19) United States
(12) Patent Application Publication
(10) Pub. No.: US 2024/0337625 A1
(43) Pub. Date: Oct. 10, 2024

(54) METHOD AND DEVICE FOR DETERMINING CHARACTERISTICS OF A MECHANICAL APPARATUS

(71) Applicant: BESTSENS AG, Niederfüllbach (DE)

(72) Inventors: Jurij ROOT, Nürnberg (DE); Phillip-Alan NEMMERT, Coburg (DE); Wolfgang DILLER, Coburg (DE); Jan SCHÖPPACH, Grub am Forst (DE); Markus JANKOWSKI, Meeder (DE)

(73) Assignee: BESTSENS AG, Niederfüllbach (DE)

(21) Appl. No.: 18/292,880

(22) PCT Filed: Jul. 13, 2022
(86) PCT No.: PCT/EP2022/069632

§ 371 Date: Jan. 26, 2024

(30) Foreign Application Priority Data
Jul. 28, 2021 (DE) 10 2021 119 664.7

(51) Int. Cl. G01N 29/04; G01N 29/34; G01N 29/44

(52) U.S. Cl. CPC G01N 29/041; G01N 29/345; G01N 29/348; G01N 29/4454; G01N 2291/012; G01N 2291/015; G01N 2291/0423; G01N 2291/102

(57) ABSTRACT

It is provided a method for determining characteristics of a mechanical apparatus, comprising the steps of exciting a continuous acoustic wave in the apparatus; receiving the acoustic wave by means of a receiver; and determining information on characteristics of the apparatus by evaluating a signal generated by the receiver on receipt of the acoustic wave. The evaluation of the signal generated by the receiver comprises a demodulation of the signal.

### CROSS-REFERENCE TO A RELATED APPLICATION

This application is a National Phase patent application of International Patent Application Number PCT/EP2022/069632, filed on Jul. 13, 2022, which claims priority of German Patent Application Number 10 2021 119 664.7, filed on Jul. 28, 2021.

### BACKGROUND

This disclosure relates to a device for determining characteristics of a mechanical apparatus and to a device for determining characteristics of a mechanical apparatus.

It is known from the prior art to obtain information with respect to a state of a mechanical apparatus by means of acoustic waves, e.g. in the form of acoustic surface waves. For example, DE 10 2016 202 176 A1 describes a method for determining characteristics of a toothing arrangement, in particular of a planetary transmission. The evaluation of a signal generated by a receiver on receipt of acoustic waves propagating in the mechanical apparatus can be complex, however, and for instance place higher demands on the electronic evaluation unit to be used.

### SUMMARY

The problem underlying the proposed solution consists in realizing the determination of characteristics of a mechanical apparatus as simply as possible.

This problem is solved by the method with features as described herein and by the apparatus with features as described herein.

Accordingly, there is provided a method for determining characteristics of a mechanical apparatus, the method including the following steps:
exciting (at least) a continuous acoustic wave in the apparatus;
receiving the acoustic wave by means of a receiver; and
determining information on characteristics of the apparatus by evaluating a signal generated by the receiver on receipt of the acoustic wave, wherein
the evaluation of the signal generated by the receiver comprises a demodulation of the signal.

The acoustic wave registered by the receiver will differ from the acoustic wave originally excited in the apparatus, as at least some of its characteristics (in particular its amplitude, phase, frequency and/or propagation speed) change during its propagation in the apparatus. This change of the wave characteristics in particular depends on the characteristics of the mechanical apparatus to be determined, so that information with respect to these characteristics can be determined by evaluating the (electrical) signal generated by the receiver in dependence on the acoustic wave received.

The excitation of the continuous acoustic wave in the apparatus is effected in particular by using a non-modulated (electrical) carrier signal with an (in particular constant) carrier frequency. For example, the excitation of the continuous acoustic wave in the apparatus is effected by means of a transmitter which generates the acoustic wave in dependence on the non-modulated carrier signal. The acoustic wave excited in the apparatus in particular is not modulated initially. Rather, a modulation of the acoustic wave is obtained only on operation of the mechanical apparatus. It is conceivable that a modulation of the excited acoustic wave is caused exclusively by a movement of at least one component of the mechanical apparatus.

The continuous (i.e. in particular not pulsed) acoustic wave so to speak serves as a carrier wave (in particular initially not modulated), which on operation of the apparatus (i.e. during a movement of at least one component of the apparatus) is modulated in dependence on the nature and/or the state (i.e. characteristics) of the mechanical apparatus. Thus, by means of the demodulation of the signal generated by the receiver it is possible to obtain information on the characteristics of the mechanical apparatus sought for. In contrast for example to the use of pulsed, high-frequency acoustic waves, the demand placed on the required sampling rate for sampling the receiver signal can be reduced. Furthermore, the excitation of a continuous acoustic wave can contribute to the fact that faster processes, e.g. processes effected at a higher frequency, can be monitored in the mechanical apparatus. For example, the mechanical apparatus is an anti-friction bearing, wherein it is conceivable that by means of the method of the solution higher rolling element speeds can also be measured, which in this case represent the characteristics of the mechanical apparatus to be determined.

As mentioned above, the excitation of the continuous acoustic wave in the apparatus is effected in particular by using a carrier signal with a carrier frequency. It is possible that the demodulation of the signal generated by the receiver is effected by means of a reference signal whose frequency depends on the carrier frequency. For example, the demodulation of the receiver signal is effected such that an amplitude and/or phase information is obtained with respect to the signal generated by the receiver. It is conceivable that the carrier frequency is not more than 1 MHz or not more than 400 kHz. However, the solution is of course not limited to a particular carrier frequency.

According to a development of the solution several different carrier frequencies are used (in particular one after the other), wherein for each of the carrier frequencies an evaluation of the signal each generated by the receiver is carried out by demodulating the signal (ES). For example, the different carrier frequencies are passed through continuously or quasi-continuously (“sweep” of the carrier frequencies).

It is conceivable in particular that the demodulation of the signal generated by the receiver is effected by using a lock-in method. This comprises mixing of a reference signal with the signal generated by the receiver, wherein the reference signal in particular has the same frequency as the signal generated by the receiver, i.e. the carrier frequency. For example, the carrier signal is used as a reference signal. The lock-in method however is known per se, so that further explanations can be omitted.

According to another exemplary embodiment of the solution, the demodulation of the signal generated by the receiver is effected by using an IQ demodulation. The IQ demodulation in particular includes mixing of a real part of the signal generated by the receiver with a reference frequency (the frequency of a local oscillator) and mixing of an imaginary part of the signal generated by the receiver with the reference frequency phase-shifted by 90°. As a result, the in-phase component (I) and the quadrature component (Q) are obtained. The method of the IQ demodulation however likewise is known per se, so that details will not be discussed at this point. It is conceivable that the IQ demodulation is effected by means of a quadrature sampling detector. For example, the I component and/or Q component of the receiver signal determined during the IQ demodulation is filtered with a low-pass filter.

It should be noted, however, that the solution is not fixed on a particular demodulation method. Rather, arbitrary demodulation methods can be applied in principle.

The acoustic wave excited in the mechanical apparatus in particular is an acoustic surface wave; for example a Lamb wave or a Lamb-Rayleigh wave. The excitation of the acoustic wave excited in the apparatus is effected for example by means of a transmitter arranged on the apparatus. For example, the transmitter is configured for exciting acoustic surface waves in the mechanical apparatus, in particular in a component of the mechanical apparatus.

The transmitter and/or the receiver for example is a piezoelectric component, i.e. a component which includes at least one piezo element. By applying a voltage (in particular of the above-mentioned carrier signal), the piezo element is put into mechanical vibrations which excite the acoustic wave in the apparatus. It is conceivable that the transmitter and the receiver are separate components arranged on the apparatus at a distance from each other. It is also possible, however, that the transmitter and the receiver are formed by a single, combined unit (a combined transmitter and receiver unit). This combined unit on the one hand excites the acoustic wave in the apparatus and also registers the acoustic wave after its propagation in the apparatus. It is possible that the combined unit includes only one single piezo element (in particular a single, common piezo crystal), with which the acoustic waves are both excited and detected in the apparatus.

The mechanical apparatus for example is a bearing (for example a plain or anti-friction bearing), a seal (for example a slide ring seal) or a toothing. As regards a possible arrangement of the transmitter and/or the receiver for determining characteristics of a plain or anti-friction bearing reference is made to WO 2012/035 169 A1, to which reference in so far is made herewith expressly. With respect to the arrangement of the transmitter and/or receiver for determining characteristics of a slide ring seal, reference is made expressly to DE 10 2015 226 311 A1.

The information on characteristics of the apparatus for example is information with respect to a lubricant present in the apparatus, a sealing ring and/or with respect to a moving component of the apparatus. It is conceivable that a thickness of a lubricating film, the quality of a lubricating film or the nature of the sealing ring is determined as characteristic. It is possible that the moving component is configured in the form of a rolling element of an anti-friction bearing, wherein the information to be determined for example is an information which is a measure for a speed or a rotation frequency of the rolling element.

The solution also relates to a device for determining characteristics of a mechanical apparatus, in particular for carrying out the method of the solution, comprising
a transmitter for exciting a continuous acoustic wave in the apparatus;
a receiver for receiving the acoustic wave; and
an evaluation unit for determining information on characteristics of the apparatus by evaluating a signal generated by the receiver on receipt of the acoustic wave, wherein
the evaluation unit is configured for demodulation of the signal generated by the receiver.

The evaluation unit for example is arranged externally to the mechanical apparatus. It is conceivable that the evaluation unit comprises at least one electronic circuit (for example in the form of a microcontroller or in the form of a circuit connected to a microcontroller), which in particular is electrically connected to the receiver. It is also possible that the evaluation unit is electrically connected to the above-mentioned transmitter for exciting the acoustic wave in the apparatus and at the same time serves for actuating the transmitter.

In addition, the exemplary embodiments explained above in connection with the method of the solution can of course also be used analogously for developing the device of the solution. For example, the evaluation unit is configured for IQ demodulation of the signal generated by the receiver.

Furthermore, the solution relates to an arrangement with a mechanical apparatus and a device of the solution for determining characteristics of the mechanical apparatus, wherein the transmitter and the receiver are arranged on the mechanical apparatus. The mechanical apparatus, as already mentioned above, for example is a bearing, a seal or a toothing.

### BRIEF DESCRIPTION OF THE DRAWINGS

The solution will be explained in detail below by means of exemplary embodiments with reference to the Figures

FIG. 1 shows a device arranged on an anti-friction bearing according to an exemplary embodiment of the solution.

FIG. 2A shows the I and Q components of a signal generated by the receiver of the device, which are determined by means of a device according to the solution.

FIG. 2B shows the amplitude of the signal determined from the I and Q components of FIG. 2A.

FIG. 2C shows the phase of the signal determined from the I and Q components of FIG. 2B.

FIG. 2D shows the frequency spectrum of the signal.

FIG. 3 shows a device arranged on slide ring seal according to another exemplary embodiment of the solution.

### DETAILED DESCRIPTION

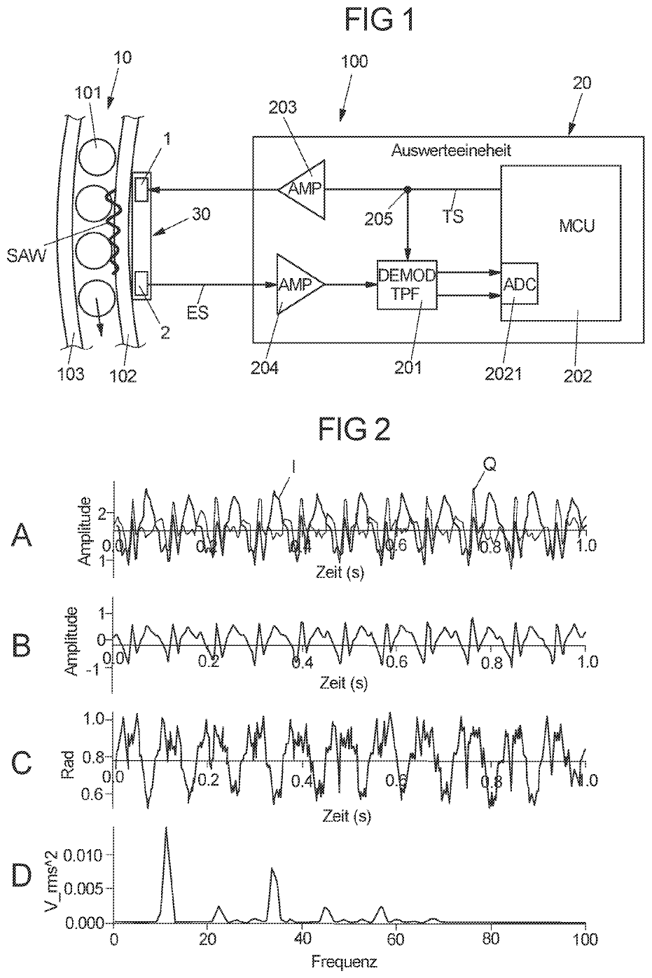

The device 100 for determining characteristics of a mechanical apparatus according to the solution, which is shown in FIG. 1, comprises a transmitter 1 for exciting acoustic waves and a receiver 2 for receiving the acoustic waves. In the exemplary embodiment of FIG. 1, the mechanical apparatus is configured in the form of an anti-friction bearing 10. The anti-friction bearing 10 comprises a plurality of rolling elements 101, for example in a spherical or cylindrical shape, which are arranged between a first ring 102 and a second ring 103. The construction of the anti-friction bearing, however, is arbitrary in principle. The transmitter 1 and the receiver 2 are each arranged on a side of the first ring 102 facing away from the rolling elements 101. By means of the transmitter 1, continuous acoustic waves in the form of continuous surface acoustic waves SAW are excited in the first ring 102, which after propagation in the ring 102 are detected by the receiver 2. With reference to the change of characteristics of surface acoustic waves SAW during their propagation in the ring 102, it is possible to draw conclusions as to the state of components of the apparatus 10, for example with respect to the state of the rolling elements 101 or of a lubricating film (not shown), which is located between the rolling elements 101 and the rings 102, 103. For details concerning the arrangement of the transmitter and the receiver on the anti-friction bearing, reference in turn is made to WO 2012/035 169 A1.

The transmitter 1 and the receiver 2 can form a common unit (a sensor 30) and for example be accommodated in a common housing and/or include a common piezo element (see above). However, this is not absolutely necessary. It is also conceivable that the transmitter and the receiver are separate units which are arranged at a distance from each other.

The device 100 also comprises an evaluation unit 20 to which the transmitter 1 and the receiver 2 each are electrically connected. The evaluation unit 20 (in particular configured in the manner of a quadrature sampling detector) comprises an IQ demodulation component 201 and a microcontroller 202 cooperating with the same. The microcontroller 202 generates a non-modulated electrical carrier signal TS which is conducted to the transmitter 1 via an (optional) amplifier 203. The transmitter 1 thereupon excites the (initially non-modulated) surface acoustic waves (SAW) with the frequency (carrier frequency) of the carrier signal TS in the ring 102 of the anti-friction bearing 10. On receipt of the surface acoustic waves SAW, the receiver 2 in turn generates an electrical signal (receiver signal ES), which is conducted to the demodulation component 201 via a (likewise optional) amplifier 204.

By means of the demodulation component 201, a demodulation of the receiver signal ES is effected. A modulation of the receiver signal ES results from a modulation of the surface acoustic waves SAW, wherein the modulation of the surface acoustic waves SAW in turn is caused by a movement of at least one component of the anti-friction bearing 10 (in particular of the rolling elements 101). In the demodulation component 201 the signal is split up into a real part and an imaginary part in the manner of the IQ demodulation, and the real and imaginary parts are mixed with the carrier signal TS. The carrier signal TS serves as a reference signal and is supplied to the demodulation component 201 via a branch 205. By mixing the real and imaginary parts of the receiver signal ES with the carrier signal TS, the I and Q components of the signal are generated.

In addition, the demodulation component 201 includes a low-pass filter or a plurality of low-pass filters by means of which the I and Q components are filtered. The filtered components are supplied to an analog-to-digital converter 2021 of the evaluation unit 20. The analog-to-digital converter 2021 can form part of the microcontroller 202. It is also conceivable that a plurality of analog-to-digital converters are present, wherein one of the analog-to-digital converters serves for converting the filtered I component and another one serves for converting the filtered Q component. The signals digitized by means of the analog-to-digital converter 2021 are further processed by means of the microcontroller 202. In particular, the desired determination of characteristics of the apparatus, here of the anti-friction bearing 10, is effected by means of the microcontroller 202 with reference to the digitized signals.

The evaluation unit 20 might also be referred to as evaluation and control unit, as it not only performs the evaluation of the receiver signal ES, but also generates the carrier signal TS and forwards the same to the transmitter 1. It is also possible, however, that the generation of the carrier signal TS is effected by means of a separate unit.

FIG. 2A by way of example shows the temporal course of the I and Q components of a receiver signal determined by means of an evaluation unit (e.g. configured analogously to the evaluation unit 20 of FIG. 1) of the device according to the solution. FIGS. 2B and 2C represent the temporal course of the amplitude (FIG. 2B) and phase (FIG. 2C) of the signal calculated by means of the I and Q components. The calculation of the amplitude or phase for example is effected by means of the evaluation unit; for example by means of an electronic circuit of the evaluation unit configured according to the microcontroller 202 of FIG. 1. FIG. 2D shows the frequency spectrum of the signal (in particular likewise determined by means of the evaluation unit). For example, the characteristics of interest of the apparatus can be determined with reference to the quantities shown in FIGS. 2A, 2B, 2C and/or 2D (in particular with reference to the amplitude shown in FIG. 2B and/or the phase shown in FIG. 2C).

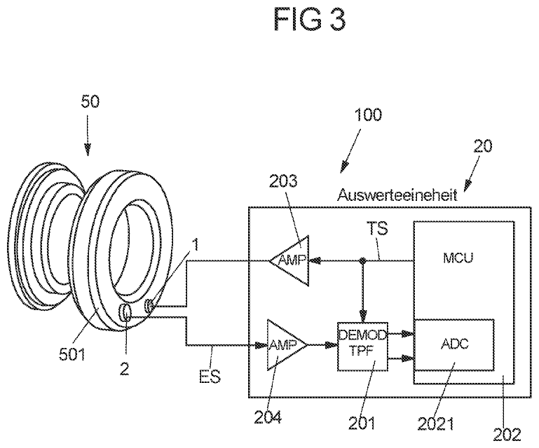

FIG. 3 relates to a modification of FIG. 1, wherein in contrast to FIG. 1 the device 100 according to the solution is not provided for monitoring an anti-friction bearing, but a slide ring seal 50. The slide ring seal 50 for example forms part of a pump. The device 100 according to the solution in turn includes a transmitter 1 and a receiver 2, wherein acoustic surface waves are generated by means of the transmitter 1 in a slide ring 501 of the slide ring seal 50 and are received by means of the receiver 2. For details concerning the arrangement of the transmitter and the receiver reference in turn is made to DE 10 2015 226 311 A1. In FIG. 3, the transmitter 1 and the receiver 2 are shown as separate units spaced apart from each other. It is also possible, however, as already repeatedly mentioned above, that the transmitter 1 and the receiver 2 are formed by a common, combined unit (a sensor). The device 100 in addition comprises an evaluation unit (evaluation and control unit) 20 formed identically to FIG. 1 for generating the carrier signal TS and for detecting and evaluating the receiver signal ES by IQ demodulation.

1. A method for determining characteristics of a mechanical apparatus, comprising:
exciting a continuous acoustic wave in the apparatus;
receiving the acoustic wave by means of a receiver; and
determining information on characteristics of the apparatus by evaluating a signal generated by the receiver on receipt of the acoustic wave,
wherein the evaluation of the signal generated by the receiver comprises a demodulation of the signal.

2. The method according to claim 1, wherein the excitation of the continuous acoustic wave in the apparatus is effected by using a non-modulated carrier signal with a carrier frequency.

3. The method according to claim 2, wherein the excitation of the continuous acoustic wave in the apparatus is effected by means of a transmitter which generates the acoustic wave in dependence on the non-modulated carrier signal.

4. The method according to claim 2, the acoustic wave excited in the apparatus initially is not modulated.

5. The method according to claim 2, wherein a modulation of the excited acoustic wave is caused exclusively by a movement of at least one component of the mechanical apparatus.

6. The method according to claim 2, wherein the demodulation of the signal generated by the receiver is effected by means of a reference signal whose frequency depends on the carrier frequency.

7. The method according to claim 1, wherein the demodulation of the signal generated by the receiver is effected such that an amplitude and/or phase information is obtained with respect to the signal.

8. The method according to claim 1, wherein the demodulation of the signal generated by the receiver is effected by using a lock-in method.

9. The method according to claim 1, wherein the demodulation of the signal generated by the receiver is effected by using an IQ demodulation.

10. The method according to claim 9, wherein at least one of
the demodulation is effected by means of a quadrature sampling detector and
the I and/or Q components of the signal (ES) determined by means of the IQ demodulation is/are filtered by means of a low-pass filter.

11. (canceled)

12. The method according to claim 2, wherein several different carrier frequencies are used, wherein for each of the carrier frequencies an evaluation of the signal each generated by the receiver is effected by demodulating the signal.

13. The method according to claim 2, wherein the carrier frequency is not more than 1 MHz or not more than 400 kHz.

14. The method according to claim 1, wherein the acoustic wave excited in the apparatus is an acoustic surface wave.

15. The method according to claim 1, wherein the excitation of the acoustic wave excited in the apparatus is effected by means of a transmitter arranged on the apparatus.

16. The method according to claim 15, wherein the transmitter and the receiver are formed by a single, combined transmitter and receiver unit.

17. The method according to claim 1, wherein the apparatus is a bearing, a seal or a toothing.

18. The method according to claim 1, wherein the information on characteristics of the apparatus is information with respect to a lubricant present in the apparatus, a scaling ring and/or with respect to a moving component of the apparatus.

19. A device for determining characteristics of a mechanical apparatus, comprising
a transmitter for exciting a continuous acoustic wave in the apparatus;
a receiver for receiving the acoustic wave; and
an evaluation unit for determining information on characteristics of the apparatus by evaluating a signal generated by the receiver on receipt of the acoustic wave,
wherein the evaluation unit is configured for demodulation of the signal-generated by the receiver.

20. The device according to claim 19, wherein
the transmitter is configured to generate the acoustic wave in dependence on a non-modulated carrier signal and
a modulation of the excited acoustic wave is effected exclusively by an operation of the mechanical apparatus.

21. (canceled)

22. An arrangement comprising a mechanical apparatus and a device according to claim 19 for determining characteristics of the mechanical apparatus, wherein the transmitter and the receiver are arranged on the mechanical apparatus.
